(19) United States
(12) Patent Application Publication
(10) Pub. No.: US 2023/0417651 A1
(43) Pub. Date: Dec. 28, 2023

(54) AUTOMATED TEST DEVICE AND TEST METHOD FOR COMPLEX ACCELERATED DEGRADATION TEST

(71) Applicants: KOREA RESEARCH INSTITUTE OF CHEMICAL TECHNOLOGY, Daejeon (KR); AB NEXO CO., LTD, Uiwang-si, Gyeonggi-do (KR)

(72) Inventors: Doo Jin BYUN, Daejeon (KR); Ho JUNG, Anyang-si (KR); Youngho PARK, Sejong-si (KR); Hyosang EOM, Daejeon (KR)

(73) Assignees: KOREA RESEARCH INSTITUTE OF CHEMICAL TECHNOLOGY, Daejeon (KR); AB NEXO CO., LTD, Uiwang-si, Gyeonggi-do (KR)

(21) Appl. No.: 18/035,793

(22) PCT Filed: Nov. 15, 2021
(86) PCT No.: PCT/KR2021/016033

§ 371 Date: Aug. 22, 2023

(30) Foreign Application Priority Data
Nov. 6, 2020 (KR) 10-2020-0147520

(51) Int. Cl. G01N 17/00

(52) U.S. Cl. CPC G01N 17/002

(57) ABSTRACT

The present invention relates to an accelerated degradation test for testing durability of a specimen by rapidly inducing a failure or degradation rate according to use environmental factors, such as temperature and humidity, and more particularly, to an automated test device and test method for a complex accelerated degradation test, capable of various and precise accelerated degradation tests by constructing a multi-test environment in a single device and automating a process of putting pre-test specimens formed of chemical materials into a test environment, transferring the specimens to other test environments, and storing tested specimens in a storage chamber.

### TECHNICAL FIELD

The present invention relates to an accelerated degradation test for testing a durability of a specimen by rapidly inducing a failure or degradation rate according to use environmental factors, such as temperature and humidity, and more particularly, to an automated test device and test method for a complex accelerated degradation test, capable of various and precise accelerated degradation tests by constructing a multi-test environment in a single device and automating a process of putting a pre-test specimen formed of chemical materials into a test environment, transferring the specimens to other test environments, and storing tested specimens in a storage chamber.

### BACKGROUND ART

Among industrial materials, chemical materials generated from petrochemical raw materials, such as plastic, synthetic rubber, synthetic resin films, paints, and adhesives, may be mostly vulnerable to high temperature exposure, and the rate of degradation may increase as the ambient temperature increases. Such degradation mostly entails chemical degradation reactions or physicochemical degradation, such as a phase change, resultantly inducing changes in physical properties or physicochemical properties. Changes in physical properties and characteristics due to representative degradation appearing in chemical materials include a degradation of mechanical physical properties, changes in optical or electrical characteristics, and the like, which may mostly lead to degree of degradation or lifespan of products. A typical environmental degradation test is used to test chemical materials, such as plastic materials, and product defects resulting therefrom. Accelerated degradation tests for use environments are also used to test accidental failures of parts or finished products, but are more commonly used to test gradual aging changes in a state of materials, i.e., accelerated degradation.

Meanwhile, based on the recognition of the fact that the same type of degradation or failure may occur within a short time if a degradation over time, which takes a long time in actual use environment, i.e., at room temperature, is performed at a high temperature in which a relatively fast degradation rate appears, an accelerated degradation test is performed to predict a quality or lifespan of products within a short time. The most commonly used accelerated degradation test is an accelerated thermal degradation test by high temperature exposure and a high temperature and humidity resistance test using a specialized equipment. In addition, a thermal shock test, an accelerated weather resistance test, and a corrosion resistance test by salt spray are accelerated degradation tests that are commonly used.

Among various environmental degradation tests, there are thermal degradation tests, high-temperature and high-humidity tests, and thermal shock tests as devices that test a degradation of materials and products mainly exposed to high-temperature environments. In order to identify a behavior according to a change for a long time in these tests, a long test of more than 5,000 hours may be required for one test, and in order to observe a degradation state and failure during the test period, a test operation process requesting a specimen treatment that takes the specimen out of a device from several to dozens of times at a certain period or a predetermined time or equipment stop is frequently included. Since an operation of equipment may be temporarily suspended for discharge of such specimens and then restarted, repeatability due to changes in the operation stop may also be problematic. A total test time of these environmental degradation tests mostly exceeds 100 hours, and in the case of a UL746B test, which evaluates a long-term heat resistance temperature of plastics, a minimum required test time may exceed 5,000 hours in some cases, and thus, an operation is necessary for processing specimens and controlling a testing machine in accordance with the end of a test, and even before the end of the test, specimen processing and testing machine operation should be performed at regular time intervals according to a test condition design, but, in the case of non-business hours, such as holidays or dawn, it may be impracticable to perform work at a fixed time, and therefore, it may be difficult to perform a test, while keeping the exact time.

That is, in order to reduce a work load due to manual work, a long work cycle needs to be selected or work may be performed earlier or later than a predetermined time, resulting in experimental errors in predicting product quality and lifespan.

More specifically, in a thermal degradation test, a constant temperature and humidity test, and a thermal shock test for plastic materials in the related art, a tester had to insert and discharge the specimen by controlling a device at a predetermined time using each test device. This not only causes the inconvenience of having to operate the device at a set time in a degradation test to observe long-term changes, but also requires the tester's attention to the consistency of a specimen discharge time and a conversion environment for each individual test condition. In particular, in the case of performing a heat resistance test, a maximum testable temperature unique to various plastic materials had to be measured or estimated in advance in order to identify an appropriate test temperature range, and a process of arbitrarily determining conditions, such as a test temperature and test time, etc. should be performed according to heat resistance lifespan prediction model or empirically.

According to the method of the related art, since a tester should intervene so that the test device operates under the designed condition at every moment of a condition change required during the entire process to perform a long-term degradation test according to a given test design, there is a problem in that testing should be performed by paying attention on equipment management continuously for a long time including nighttime and holiday work hours.

### DISCLOSURE

### Technical Problem

The present invention has been made to solve the above problems, and an object of the present invention is to provide an automated test device and test method for a complex accelerated degradation test that enables various accelerated degradation tests by providing a plurality of chambers for testing heat resistance, moisture resistance, thermal shock, etc., and automating a process of inserting a specimen into each chamber and transferring, and discharging the specimen.

Another object of the present invention is to provide an automated test device and a test method for a complex accelerated degradation test, capable of discharging a tested specimen from a chamber at a determined time and storing the specimen in a storage chamber so that a sample may be stored at a desired period and at an accurate time and a manual process time to check a change over time of the specimen may be flexibly adjusted to reduce a user's work load.

Another object of the present invention is to provide an automated test device and a test method for a complex accelerated degradation test, capable of inserting another specimen into a specimen accommodation space in a chamber according to discharging of a specimen, thereby increasing test efficiency.

### Technical Solution

In one general aspect, a heat management system includes: an automated test device for a complex accelerated degradation test including: a plurality of chambers having a test space formed therein to accommodate a specimen and including a door for inserting the specimen into the test space or discharging the specimen from the test space and an environmental test parameter configured to adjust an internal environment; a transfer unit provided to insert or discharge specimens into or from each of the chambers; and a controller configured to control the door and the transfer unit, wherein the plurality of chambers are each controlled to different environments.

The door may include: an outer door configured to insert the specimen from the outside or discharge the specimen to the outside and manually opened and closed to be used for inspection and repair according to device malfunction, and an inner door provided in the test device and configured to insert the specimen into the test space or discharge the specimen from the test space by the transfer unit, wherein the transfer unit automatically inserts or discharges individual specimens into or from each of the chambers through a passage connecting the inner doors respectively provided in the chambers.

The automated test device may further include: a storage chamber including a test space, for storing a pre-test specimen or tested specimen, and including a door for inserting or discharging the specimen and an environmental test parameter configured to maintain an internal environment in a certain standard environment, wherein the controller inserts the pre-test specimen of the storage chamber into each chamber through the transfer unit or transfers and inserts the tested specimen into the storage chamber from each chamber.

The environmental test parameter of the other of the plurality of chambers may maintain the internal environment in a certain standard environment so that any one of the plurality of chambers stores the tested specimen after the test is terminated, and the controller may insert the tested specimen into the other of the plurality of chambers through the transfer unit.

The chamber may include: a first chamber which is a high-temperature test chamber maintaining room temperature of 30° C. or less and controlled in temperature from 70 to 290° C.; and a second chamber which is a climatic chamber for temperature and humidity reliability testing controlled in relative humidity from 20% to 95% in a range of 10 to 90° C.

The chamber may include: a first chamber which is a high-temperature test chamber maintaining room temperature of 30° C. or less and controlled in temperature from 70 to 290° C.; and a second chamber which is a low-temperature test chamber controlled in temperature from −40 to 180° C.

The automated test device may further include: a casing accommodating the plurality of chambers and the transfer unit, wherein the casing includes an air circulation device or air conditioning device so that an internal environment maintains a constant state.

The plurality of chambers may include a heat deflection test tool configured to measure thermal deformation of the specimen, and the controller may stop the test operation when detecting thermal deformation through the heat deflection test tool.

The plurality of chambers may further include a gas sensor configured to detect combustion of the specimen, and the controller stops test operation when combustion is detected through the gas sensor.

The chamber may include a stage and a cartridge, on which the specimen is mounted, slidably coupled in a horizontal direction on the stage, and the stage may have a disc shape to be rotatable about a rotation axis, and the cartridge is radially disposed in a circumferential direction of the stage.

The chamber may include a stage and a cartridge, on which the specimen is mounted, slidably coupled in a horizontal direction on the stage, and the cartridges may be spaced apart from each other by a predetermined distance in a longitudinal direction of the stage.

The chamber may be coated with fluororesin, fluororesin film, fluororesin composite material, or ceramic.

In another general aspect, a test method using an automated test device for a complex accelerated degradation test includes: a high-temperature thermal degradation test mode in which the second chamber is maintained under a room temperature condition of 30° C. or less, the first chamber is maintained in a high-temperature environment, and the thermally degraded specimen is sequentially transferred to the second chamber at room temperature at every determined time according to required test conditions; and a temperature/humidity exposure test mode in which the first chamber is maintained at a room temperature condition of 30° C. or less, and the second chamber is implemented with a constant temperature and humidity control function capable of controlling temperature and humidity of the second chamber to satisfy the 85° C./85% RH test condition, so that, after a temperature and humidity exposure test is performed in the second chamber, the specimen, on which the exposure test is terminated, is transferred to the first chamber under room temperature conditions for a determined time according to the test conditions.

The test method may further include: a thermal shock test mode in which the first chamber is operated under a high-temperature condition and the second chamber is operated under a low-temperature condition necessary for a thermal shock test, and an individual specimen is repeatedly moved between the first chamber under a high-temperature condition and the second chamber under a low-temperature condition according to a determined period at a predetermined time according to test design conditions.

A test time for each specimen for each individual test temperature within a temperature range between highest and lowest temperatures of a test temperature at which a degradation test is to be performed and a calculated test temperature range may be calculated through the controller, and chamber insertion and discharge time for each individual specimen may be automatically determined.

A degradation accelerated coefficient or a degradation activation energy estimation value may be received based on a highest test temperature permissible for the specimen, an actual or estimated use temperature, an anticipated or expected thermal degradation time or degradation lifespan at the actual use temperature, and a high-temperature test temperature performed by an acceleration test, and a temperature stage of the thermal degradation test, an individual test temperature of each stage, a test time for each specimen given for each test temperature, and a specimen discharge interval in a total test time may be calculated.

The controller may perform, after the test starts, a process of correcting or supplementing an error of test conditions in progress during testing by a method of inputting an intermediate measurement value of the test in progress before the test is terminated to improve design completeness of the thermal degradation test.

When the thermal deformation temperature of the specimen measured in real time is higher than a highest test temperature input before the test, the highest test temperature may be corrected to a thermal deformation temperature measured in real time or lower, and the test conditions may be corrected before or during the thermal degradation test to perform the test under the changed conditions.

The thermal degradation test may be conducted at least two different temperatures within an allowable test temperature range, and an optimal combination of an order of setting and changing a test temperature of each chamber, a test time for each specimen in an individual chamber, and test order may be designed so that the entire thermal degradation test is completed within a minimum test time according to the number of chambers provided in the device and the stage of each test temperature.

When excessive thermal decomposition or volatile gas occurs due to degradation beyond an allowable level in the thermal degradation test, the test may be stopped to lower a temperature of the test chamber, and the specimens under the corresponding test conditions may be moved to a specimen preservation chamber.

### Advantageous Effects

The automated test device and test method for a complex accelerated degradation test of the present invention having the above configuration provide a complex test function capable of various accelerated degradation test functions within one device and implement a degradation test under individual or complex test conditions by automated insertion and discharge control, thereby minimizing a manual process.

Specifically, a high-temperature thermal degradation test, a high-humidity exposure test, and a thermal shock test with automated specimen insertion and discharge may be performed within one device, and a complex accelerated degradation test of performing the aforementioned degradation tests, which were not possible with the degradation test devices of the related art, within one device in various connection orders of an automated method may be performed.

In addition, the present invention has a built-in program for designing degradation test conditions according to the Arrhenius equation for accelerated degradation lifespan testing, to provide a function of calculating a test temperature and number of specimens for predicting degradation lifespan, including lifespan prediction for guaranteeing reliability, and a test time for each specimen within the device, controlling to automatically set a temperature of a test chamber and automatically move a specimen to be inserted and discharged with a resultant calculated value.

In addition, in order to solve safety problems that may occur during a long-term high-temperature degradation test, a gas sensor that may monitor excessive thermal damage in real time is built in to prepare for combustion and fire hazards during a test, and a thermal deformation temperature or softening temperature measuring instrument or sensor is provided to prevent a test error due to an improper test temperature setting.

### BRIEF DESCRIPTION OF THE DRAWINGS

FIG. 1 is a schematic diagram of an automated test device for a complex accelerated degradation test according to an embodiment of the present invention.

FIG. 2 is a schematic view of a test device having a vertical chamber arrangement structure according to an embodiment of the present invention.

FIG. 3 is a schematic view of a test device having a horizontal chamber arrangement structure according to another embodiment of the present invention.

FIG. 4 is a schematic diagram of a chamber and a transfer unit having a rotary specimen transfer structure according to an embodiment of the present invention.

FIG. 5 is a schematic view of a chamber and a transfer unit having a slide-type specimen transfer structure according to another embodiment of the present invention.

### DETAILED DESCRIPTION OF MAIN ELEMENTS

1000: complex accelerated degradation test device
10, 20, 30: specimen
100, 200, 300: first to third chambers
101, 201, 301: first to third environmental test parameters
102, 202, 302: stage
105, 205, 305: cartridge
110, 210, 310: inner door
120, 220, 320: outer door
150, 250: heat deflection test tool(method)
160, 260: gas sensor
500: transfer unit
510; elevating unit
520, 560: horizontal moving unit
530, 570: specimen holder
550; horizontal transfer unit
600: controller
700: casing
710: air conditioning device
720: entrance door

### BEST MODE

The present invention relates to an automated test device and test method for a complex accelerated degradation test for testing a degradation or failure occurring in a material or product exposed to a high temperature environment or various indoor/outdoor environments.

The present invention provides a complex accelerated degradation test device equipped with comprehensive test regulation and control functions, including calculation algorithms and temperature control for thermal degradation test design and test chamber movement and discharge control of specimens. In an accelerated thermal degradation lifespan test for measuring or simulating a temperature dependence of a thermal degradation rate of materials and products that follow a thermal degradation mechanism, the present invention includes a calculation algorithm for a required test design to provide a smart test function of calculating a test temperature and test time for thermal degradation and controlling a test device to operate under estimated test design conditions. To this end, the present invention includes a test device including a device control algorithm of designing test conditions by providing a minimum input value according to a specimen and purpose and controlling and completing a thermal degradation test through the procedure of searching and confirming the test conditions and simultaneously includes at least two separate functions equipped with a thermal degradation test chamber including a specimen transfer device that automatically inserts and discharges specimens and a climatic chamber for temperature and humidity reliability testing that may be used as a specimen preservation chamber separately provided so that the device may be controlled.

In addition, the present invention implements a comprehensive equipment control function including at least six climatic data sets as climatic conditions representing various climates around the world and a thermal degradation accelerated test calculation algorithm designed based on climatic data sets for the optimal design of test conditions, including a thermal deformation temperature or softening temperature measuring instrument and sensor for determining the highest test temperature, and including a gas detection sensor that may monitor excessive heat damage and thermal decomposition in real time.

Hereinafter, an embodiment of the present invention as described above will be described in detail with reference to the drawings.

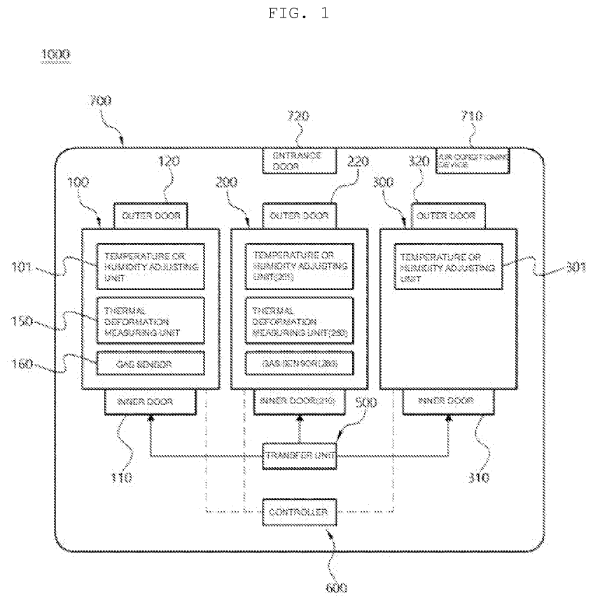

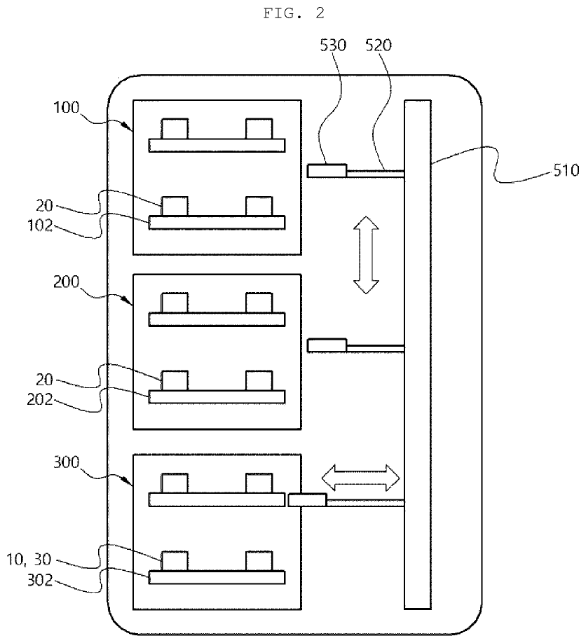

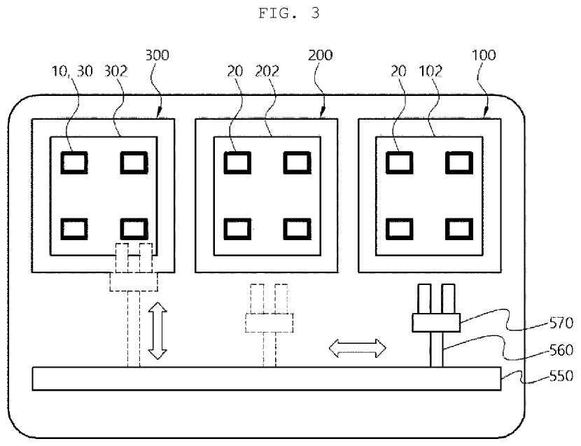

FIG. 1 shows a schematic diagram of an automated test device 100 (hereinafter referred to as □test device□) for a complex accelerated degradation test according to an embodiment of the present invention. In addition, FIG. 2 shows a schematic diagram of the test device 100 having a vertical chamber arrangement structure according to an embodiment of the present invention, and FIG. 3 shows a test device having a horizontal chamber arrangement structure according to another embodiment of the present invention.

As shown, the test device 1000 includes first and second chambers 100 and 200 for a degradation test, and a preservation chamber 300 in which a pre-specimen 10 put into the first and second chambers 100 and 200 and a post-specimen 30 tested in the first and second chambers 100 and 200 are stored. In addition, the test device 1000 includes a transfer unit 500 transferring the specimens 10, 20, and 30 between the first chamber 100, the second chamber 200, and the preservation chamber 300 and a controller 600 controlling an internal environment of the first chamber 100 and the second chamber 200 and driving of the transfer unit 500 accommodating the above configuration. In another embodiment, the test device 1000 may include a third chamber providing a test environment different from the first and second chambers 100 and 200 instead of the preservation chamber 300. In another embodiment, the preservation chamber 300 may be omitted. In this case, either the first chamber 100 or the second chamber 200 may serve as the preservation chamber 300 instead.

The first and second chambers 100 and 200 may include adjusting units 101, 201 and 301 so that various environments for performing an accelerated degradation test may be simulated, and the adjusting units may include a temperature adjusting unit or a humidity adjusting unit or may include both the temperature adjusting unit and the humidity adjusting unit. For example, the first chamber 100 may be a high-temperature test chamber capable of controlling a temperature from 70 to 290° C., and the second chamber 200 may be a climatic chamber for temperature and humidity reliability testing capable of controlling relative humidity from 20 to 95% within a range of 10 to 90° C.

In another embodiment, the first chamber 100 may be provided with a lighting facility for reproducing an environment exposed to outdoor sunlight, or may be provided with a salt spray device for reproducing an environment exposed to fine salt in the air at the seaside.

Inner doors 110, 210, 310 and outer doors 120, 220, 320 may be provided in the first and second chambers 100 and 200 and the preservation chamber 300. The outer doors 110, 210, and 310 are used to manually control the insertion and discharge of specimens, or to inspect and repair device malfunctions, and the inner doors 120, 220, and 320 are configured to automatically open and close in conjunction with insertion and discharge of the specimen by the transfer unit 500. For example, the inner doors 120, 220, and 320 may be configured to operate in conjunction with the transfer unit 500 which automatically performs a process of moving a specimen from the first chamber 100 to the second chamber 200, or conversely, from the second chamber 200 to the first chamber 100.

In addition, heat deflection test tools 150 and 250 may be provided on the first and second chambers 100 and 200. The heat deflection test tools 150 and 250 are provided to measure thermal deformation of the specimen in real time in order to measure the allowable maximum test temperature during the accelerated degradation test. The heat deflection test tools 150 and 250 may include, for example, a rod for measuring a thermal deformation temperature or a probe for measuring a softening temperature, a load application device and a displacement sensor for measuring a minute displacement on a surface of the specimen. Through the heat deflection test tools 150 and 250, it is possible to collect data necessary for redesigning and improving test conditions before or during the thermal degradation test. Therefore, in the present invention, a test temperature and test time for the accelerated thermal degradation test may be changed and reset by the device itself during the test, and a part intelligent test that automatically performs a redesigned test condition by changing input values required for the test condition by real-time measurement may be performed, thereby shortening a test time and improving test precision.

In addition, on the first and second chambers 100 and 200, gas sensors 160 and 260 may be provided for self-diagnosis in preparation for device malfunctions and risks occurring during a high-temperature accelerated degradation test conducted by designing automatically set test conditions. When the gas sensors 160 and 260 detect excessive thermal decomposition or volatile gas occurring due to unacceptable degradation during the accelerated degradation test, the gas sensors 160 and 260 may stop the test by itself and move the specimens in progress under the corresponding test conditions to move the specimen preservation chamber. Accordingly, the controller 600 may provide a safety function of automatically stopping the test in progress and restoring an operating condition of the device to a test preparation state when an abnormality is detected through the gas sensor.

In addition, inner surfaces of the first and second chambers 100 and 200 may be coated with a fluororesin or a fluororesin film. Among the components of the fluororesin coating, a fine reinforcing agent capable of imparting high hardness characteristics to ceramics, titanium metal, and the like may be included. Through this fluororesin coating, the first and second chambers 100 and 200 may suppress metal oxidation and adhesion of contaminants inside a test chamber due to exposure to high temperatures for a long time, and may be cleaned relatively easily even after contaminants are attached. This may prevent errors in the accelerated test due to thermal oxidation acceleration by a transition metal component of a polymeric material, which may occur when metal oxides, such as iron oxide, contaminate the specimen in the high-temperature test chamber in the form of fine particles.

The preservation chamber 300 is provided to store the pre-specimen 10 and the post-specimen 30, and provides an environment capable of minimizing additional degradation of the specimens 10 and 30 other than the test conditions. For example, the preservation chamber 300 may be operated under standard conditions, a temperature may be maintained at 23 to 25° C., and the relative humidity may be maintained at about 50%. In particular, the preservation chamber 300 may provide a function of stabilizing the specimen 30 by storing the specimen 30 under standard conditions after the test, and the user may immediately evaluate the state of the specimen 30 after the stabilized test.

As shown in FIGS. 2 and 3, the first chamber 100, the second chamber 200, and the preservation chamber 300 may be arranged vertically or horizontally side by side depending on the user's intention according to a laboratory environment. Stages 102, 202, and 302 for mounting the specimens 10, 20, and 30 may be provided inside the first to third chambers 100, 200, and 300, and if necessary, the stages 102, 202, and 302 may be stacked in multiple stages. The transfer unit 500 may be, for example, a horizontal transfer type (tunnel type) specimen transfer device that moves between each chamber when each chamber is connected horizontally, and may be an elevating type specimen transfer device that vertically moves between each chamber when each chamber is connected vertically. More specifically, when the chambers 100, 200, and 300 are vertically arranged as shown in FIG. 2 to insert or discharge the specimen into or from each chamber, the transfer unit 500 may include a elevating unit 510, a horizontal moving unit 520, and a specimen holder 530, and in another embodiment, as shown in FIG. 3, when the chambers 100, 200, and 300 are horizontally arranged, the transfer unit 500 may include a horizontal transfer unit 550, a horizontal moving unit 560, and a specimen holder 570.

The elevating specimen transfer device may be any one of a multi-elevator type that individually moves specimens through a plurality of elevators provided to correspond to each specimen, or may be a single elevator type that moves the specimens to a transfer device installed independently in a separate space from a rotary type specimen holder provided in each chamber as shown in FIG. 2. The specimen holder 530 is configured to move up and down through the elevating unit 510 and horizontally reciprocate through the horizontal moving unit 520 to transfer the specimen accommodated in any one of the first chamber 100, the second chamber 200, and the preservation chamber 300 to the other chamber.

As another embodiment, as shown in FIG. 3, the specimen holder 570 is configured to horizontally move in a direction in which the chambers are arranged through the horizontal transfer unit 550 and is configured to be close to or spaced apart from the chamber through the horizontal move unit 560 to transfer the specimen accommodated in any one of the first chamber 100, the second chamber 200, and the preservation chamber 300 to the other chamber.

The controller 600 is a component for automatically performing the complex accelerated degradation test, controls a temperature or humidity adjusting unit of the first to third chambers 100, 200, and 300, collects information from the heat deflection test tool 150 and the gas sensor 160 to determine whether to the test is stopped, and controls opening and closing of the inner doors 110, 210, and 310 provided in each chamber, and the transfer unit 500.

The casing 700 is formed as an enclosure in which the first and second chambers 100 and 200, the preservation chamber 300, and the transfer unit 500 are accommodated, and an air conditioning device 710 may be provided on the casing 700 so that heat or humidity transferred during opening of the first and second chambers 100 and 200 does not affect other chambers and transfer unit 500. The air conditioning device may be an air circulation device or an air conditioning device for maintaining an optimal environment for the operation of the transfer unit 500, for example, a relative humidity condition of 50% or less of room temperature. In addition, the casing 700 may be provided with an entrance door 720 for a user's entry.

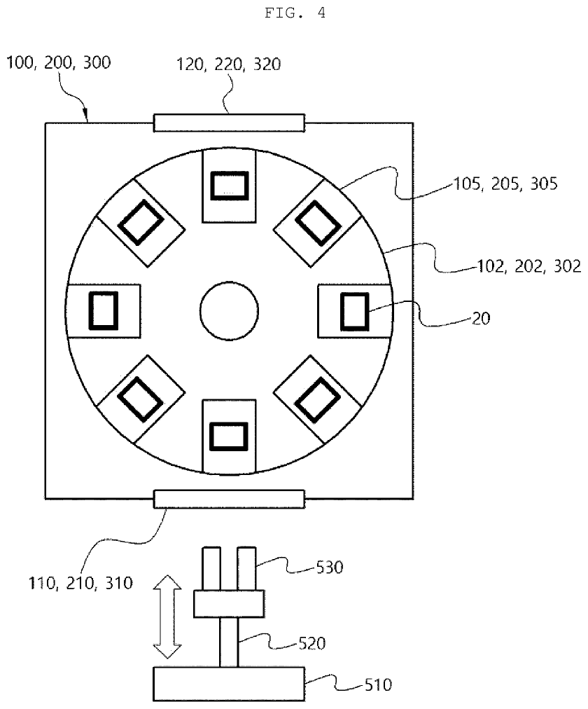

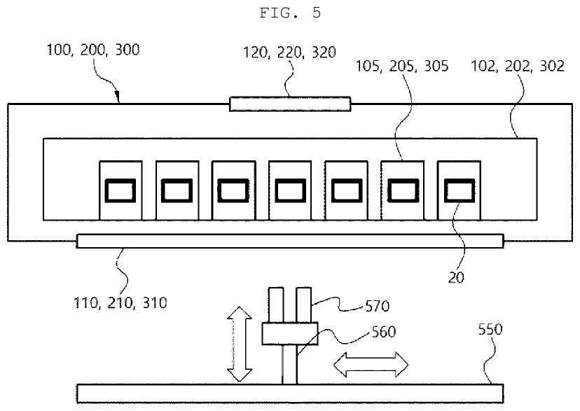

FIG. 4 is a schematic diagram of a chamber and a transfer unit having a rotary type specimen transfer structure according to an embodiment of the present invention, and FIG. 5 is a schematic diagram of a chamber and a transfer unit having a slide type specimen transfer structure according to another embodiment of the present invention.

As shown in FIG. 4, the stages 102, 202, and 302 respectively provided in the chambers 100, 200, and 300 are configured to rotate, and cartridges 105, 205, and 305 on which the specimens 10, 20, and 30 are mounted in a circumferential direction may be radially slidably coupled at regular intervals. Accordingly, the specimen holder 530 of the transfer device is configured to insert or discharge all cartridges 105, 205, 305 at any one point by rotation of the stages 102, 202, and 302.

In another embodiment, as shown in FIG. 5, the stages 102, 202, and 302 respectively provided in the chambers 100, 200, and 300 include the plurality of cartridges 105, 205, and 305 arranged at regular intervals in a longitudinal direction. In a state in which the stage is fixed, the specimen holder 570 moves horizontally in the longitudinal direction of the stage through the horizontal transfer unit 550, and then the cartridges 105 205 and 305 are inserted or discharged through the horizontal moving unit 560.

Hereinafter, a test method using the automated test device for a complex accelerated degradation test of the present invention configured as described above will be described in detail.

As described above, the first chamber 100 may be a high-temperature test chamber in which a temperature may be controlled from 70 to 290° C., and the second chamber 200 may be a climatic chamber for temperature and humidity reliability testing in which a relative humidity may be controlled by 20 to 95% in a range of 10 to 90° C. In addition, a plurality of first chambers 100 may be provided to independently perform degradation tests at different temperatures, respectively, and the second chamber 200 may perform testing at a lower temperature than that of the first chamber 100 and may be adjusted at or below room temperature, and may have a function capable of high humidity exposure test by temperature and humidity control.

In addition, through a process of transferring the specimen of the first chamber 100 to the second chamber 200 using a temperature difference between the first chamber 100 and the second chamber 200 or rapidly transferring the specimen from the second chamber 200 to the first chamber 100, a function of effectively performing a thermal shock test in units of individual specimens may be provided. In the case of performing a thermal shock test with only one chamber in the related art, problems may arise in that it takes time to lower or increase the temperature or a thermal shock environment cannot be accurately simulated because the temperature is gradually changed. In addition, when performing a thermal shock test with two or more chambers in the related art, there is a disadvantage in that the thermal shock test of individual specimen units cannot be performed because the entire specimens put into the test are transferred.

After the test is automatically terminated at a set time according to the test design conditions through the controller 600, the specimen exposed to the test environment of the first chamber 100 or the second chamber 200 are automatically transferred to the preservation chamber maintained under standard or specific specimen preservation conditions through a transfer unit so that the user may check a state of the specimen.

In another embodiment, when the preservation chamber is not provided, if the second chamber 200 is operated under standard temperature and humidity or specific preservation conditions, the test for the specimen subjected to thermal degradation in the first chamber 100 automatically terminated at a predetermined time according to test design conditions and the specimen is automatically transferred to the second chamber 200 maintained under standard or specific specimen preservation conditions so that the user may check the state of the specimen. Conversely, when the first chamber 100 is operated at room temperature, the specimen subjected to a moisture exposure test in the second chamber 200 is automatically transferred to the first chamber 100 maintained at room temperature from a moisture exposure test chamber at a predetermined time according to the test design conditions, so that the user may check the state of the specimen.

In addition, the present invention may provide a function of performing various complex cycle tests, for example, a complex cycle test including a cycle of continuously performing a thermal shock test between −20° C. to 120° C. of performing a high humidity exposure test of 60° C. and 90% relative humidity, through the second chamber, which was impossible to provide in the related art and apparatus, performing thermal degradation test at a 180° C. or higher through the first chamber, rapidly transferring the specimen back to the third chamber having a temperature difference from the first chamber or the second chamber in which the temperature is changed to −20° C. during the first chamber test, and then moving the specimen again to the first chamber having the test temperature to 120° C., in a continuous and automated manner within one device.

Meanwhile, in the present invention, a range of temperatures to perform a test and a test time given to each specimen at each test temperature at which the test is to be performed are calculated by a calculation algorithm of the controller 600 provided in the device to automatically determine whether the specimen moves, thereby automatically determining test conditions by an input value setting required for the calculation program of designing the test conditions, without manual operation by equipment operating personnel for inserting and discharging of specimens at various temperatures required for lifespan degradation test under an accelerated condition. Therefore, in the present invention, the degradation lifespan test is performed by automated high-temperature acceleration conditions through a transfer unit controlled by the test conditions calculated in the test device equipped with the calculation program.

The calculation program may automatically calculate a temperature of a thermal degradation test which is automatically performed, a test time for each test temperature, and a specimen discharge interval in a total test time by, first, inputting a maximum test temperature allowable in a material and product to be tested and an actual use temperature, secondly, inputting a thermal degradation time or degradation lifespan anticipated or expected at the actual use temperature, and thirdly, inputting a degradation acceleration factor or degradation activation energy estimation value based on the test temperature performed under accelerated conditions. In this manner, the present invention determines setting of conditions 101, 201, and 301, such as test temperature and test time of the respective chambers 100, 200, and 300 and control of the specimen transfer device 500 for inserting and discharging specimens, and automatically control the same.

In addition, the controller 600 of the present invention has a function of redesigning by improving completeness of an accelerated thermal degradation test, compared to initially designed test conditions by including a process of correcting or adding a preset test condition as a method of inputting some result values of a test in progress, for example, degradation test result values of partially finished specimens, before all designed tests are finished after the accelerated test starts, thereby allowing re-design operation of the test conditions in progress to reduce a test time and improve test precision.

In the test method according to an embodiment of the present invention, the thermal degradation test may be performed at least two, preferably, four or more different temperatures, a calculation algorithm of selecting an optimal combination of a test temperature, a test time, and a test order of each test chamber is included so that the entire thermal degradation test may be terminated within a minimum test time according to the number of test temperature and the number of chambers provided in the test device, and a re-designing function of the test conditions of correcting the test conditions in progress or reflecting an additional test condition may be included as a method of inputting the degradation result value of the specimen that has already been performed before the end of the entire test after the accelerated degradation test started to improve completeness of the initially designed test conditions during testing.

In addition, the test method of the present invention may insert specimens for other tests into a free space on the remaining stage as the tested specimens are discharged, and independently control the test time of each specimen to minimize an empty space on the test stage, thereby increasing test efficiency.

Technical ideas should not be interpreted as being limited to the above-described embodiments of the present invention. Not only is the scope of application diverse, but also various modifications and implementations are possible at the level of those skilled in the art without departing from the gist of the present invention claimed in the claims. Therefore, such improvements and changes fall within the protection scope of the present invention as long as they are obvious to those skilled in the art.

1. An automated test device for a complex accelerated degradation test, the automated test device comprising:
a plurality of chambers having a test space formed therein to accommodate a specimen and including a door for inserting the specimen into the test space or discharging the specimen from the test space and an environmental test parameter configured to adjust an internal environment;
a transfer unit provided to insert or discharge specimens into or from each of the chambers; and
a controller configured to control the door and the transfer unit,
wherein the plurality of chambers are each controlled to different environments.

2. The automated test device of claim 1, wherein
the door includes:
an outer door configured to insert the specimen from the outside or discharge the specimen to the outside and manually opened and closed to be used for inspection and repair according to device malfunction, and
an inner door provided in the test device and configured to insert the specimen into the test space or discharge the specimen from the test space by the transfer unit,
wherein the transfer unit automatically inserts or discharges individual specimens into or from each of the chambers through a passage connecting the inner doors respectively provided in the chambers.

3. The automated test device of claim 1, further comprising:
a storage chamber including a test space, for storing a pre-test specimen or tested specimen, formed in any one of the plurality of chambers and including a door for inserting or discharging the specimen and an environmental test parameter configured to maintain an internal environment in a certain standard environment,
wherein the controller inserts the pre-test specimen of the storage chamber into each chamber through the transfer unit or transfers and inserts the tested specimen into the storage chamber from each chamber.

4. The automated test device of claim 1, wherein
the environmental test parameter of the other of the plurality of chambers maintains the internal environment in a certain standard environment so that any one of the plurality of chambers stores the tested specimen after the test is terminated, and
the controller inserts the tested specimen into the other of the plurality of chambers through the transfer unit.

5. The automated test device of claim 1, wherein
the chamber includes:
a first chamber which is a high-temperature test chamber controlled in temperature from 70 to 290° C.; and
a second chamber which is a climatic chamber for temperature and humidity reliability testing controlled in relative humidity from 20% to 95% in a range of 10 to 90° C.

6. The automated test device of claim 1, wherein
the chamber includes:
a first chamber which is a high-temperature test chamber controlled in temperature from 70 to 290° C.; and
a second chamber which is a low-temperature test chamber controlled in temperature from −40 to 180° C.

7. The automated test device of claim 1, further comprising:
a casing accommodating the plurality of chambers and the transfer unit,
wherein the casing includes an air circulation device or air conditioning device so that an internal environment maintains a constant state.

8. The automated test device of claim 1, wherein
the plurality of chambers include a heat deflection test tool configured to measure thermal deformation of the specimen, and
the controller stops the test operation when detecting thermal deformation through the heat deflection test tool.

9. The automated test device of claim 1, wherein
the plurality of chambers further include a gas sensor configured to detect combustion of the specimen, and
the controller stops test operation when combustion is detected through the gas sensor.

10. The automated test device of claim 1, wherein
the chamber includes a stage and a cartridge, on which the specimen is mounted, slidably coupled in a horizontal direction on the stage, and
the stage has a disc shape to be rotatable about a rotation axis, and the cartridge is radially disposed in a circumferential direction of the stage.

11. The automated test device of claim 1, wherein
the chamber includes a stage and a cartridge, on which the specimen is mounted, slidably coupled in a horizontal direction on the stage, and
the cartridges are spaced apart from each other by a predetermined distance in a longitudinal direction of the stage.

12. The automated test device of claim 1, wherein the chamber is coated with fluororesin, fluororesin film, fluororesin composite material, or ceramic.

13. A test method using an automated test device for a complex accelerated degradation test of claim 1 the test method comprising:
a high-temperature thermal degradation test mode in which the second chamber is maintained under a room temperature condition of 30° C. or less, the first chamber is maintained in a high-temperature environment, and the thermally degraded specimen is sequentially transferred to the second chamber at room temperature at every determined time according to required test conditions; and
a temperature/humidity exposure test mode in which the first chamber is maintained at a room temperature condition of 30° C. or less, and the second chamber is implemented with a constant temperature and humidity control function capable of controlling temperature and humidity of the second chamber to satisfy the 85° C./85% RH test condition, so that, after a temperature and humidity exposure test is performed in the second chamber, the specimen, on which the exposure test is terminated, is transferred to the first chamber under room temperature conditions for a determined time according to the test conditions.

14. The test method of claim 13, further comprising:
a thermal shock test mode in which the first chamber is operated under a high-temperature condition and the second chamber is operated under a low-temperature condition necessary for a thermal shock test, and an individual specimen is repeatedly moved between the first chamber under a high-temperature condition and the second chamber under a low-temperature condition according to a determined period at a predetermined time according to test design conditions.

15. The test method of claim 13, wherein a test time for each specimen for each individual test temperature within a temperature range between highest and lowest temperatures of a test temperature at which a degradation test is to be performed and a calculated test temperature range is calculated through the controller, and chamber insertion and discharge time for each individual specimen are automatically determined.

16. The test method of claim 13, wherein
a degradation accelerated coefficient or a degradation activation energy estimation value is received based on a highest test temperature permissible for the specimen, an actual or estimated use temperature, an anticipated or expected thermal degradation time or degradation lifespan at the actual use temperature, and a high-temperature test temperature performed by an acceleration test, and
a temperature stage of the thermal degradation test, an individual test temperature of each stage, a test time for each specimen given for each test temperature, and a specimen discharge interval in a total test time are calculated.

17. The test method of claim 13, wherein the controller performs, after the test starts, a process of correcting or supplementing an error of test conditions in progress during testing by a method of inputting an intermediate measurement value of the test in progress before the test is terminated to improve design completeness of the thermal degradation test.

18. The test method of claim 13, wherein, when the thermal deformation temperature of the specimen measured in real time is higher than a highest test temperature input before the test, the highest test temperature is corrected to a thermal deformation temperature measured in real time, and the test conditions are corrected before or during the thermal degradation test to perform the test under the changed conditions.

19. The test method of claim 13, wherein the thermal degradation test is conducted at least two different temperatures within an allowable test temperature range, and an optimal combination of an order of setting and changing a test temperature of each chamber, a test time for each specimen in an individual chamber, and test order is designed so that the entire thermal degradation test is completed within a minimum test time according to the number of chambers provided in the device and the stage of each test temperature.

20. The test method of claim 13, wherein, when excessive thermal decomposition or volatile gas occurs due to degradation beyond an allowable level in the thermal degradation test, the test is stopped to lower a temperature of the test chamber to room temperature, and the specimens under the corresponding test conditions are moved to a specimen preservation chamber.
